(19) United States
(12) Patent Application Publication
(10) Pub. No.: US 2013/0309627 A1
(43) Pub. Date: Nov. 21, 2013

(54) TUBULAR DENTAL REINFORCEMENT PREFORM FOR FORMING A DENTAL RETAINING BAND

(71) Applicants: Bruno Clunet Coste, Saint Etienne de Crossey (FR); Bernard Maneuf, Voiron (FR); Andre Collombin, Voiron (FR)

(72) Inventors: Bruno Clunet Coste, Saint Etienne de Crossey (FR); Bernard Maneuf, Voiron (FR); Andre Collombin, Voiron (FR)

(73) Assignee: BIO COMPOSANTS MEDICAUX, Tullins (FR)

(21) Appl. No.: 13/983,399

(22) PCT Filed: Jan. 31, 2012
(86) PCT No.: PCT/FR2012/000039

§ 371 Date: Aug. 2, 2013

(30) Foreign Application Priority Data
Feb. 2, 2011 (FR) 1100324
Feb. 2, 2011 (FR) 1100325

(51) Int. Cl. A61C 5/00; A61C 13/15

(52) U.S. Cl. CPC A61C 5/007; A61C 19/003
USPC 433/29; 433/215

(57) ABSTRACT

The invention relates to a tubular dental reinforcement preform formed by a cord made from woven fibres. The cord is impregnated and filled by a polymerizable resin and is able, by isostatic crushing, to take the shape of a strip without breaking of the woven fibres constituting the cord, the polymerizable resin being able to creep through the cord to form two lateral parts. The invention also relates to a production method of a dental contention strip from such a tubular reinforcement preform.

### BACKGROUND OF THE INVENTION

The invention relates to a tubular dental reinforcement preform formed by a cord made from woven fibres.

### STATE OF THE ART

Reinforcement means are used in manufacture of dental splints or retaining bands. Known dental contention splints can be formed by metal threads or metal wisps. The drawback of metal splints remains their unaesthetic appearance, their rigidity and the fact that they have to be sunk in resins to improve the aspect.

The document U.S. Pat. No. 2,755,552 describes reinforcements made from fibres to reinforce dental prostheses, crowns or to manufacture invisible and colourless contention splints.

The document FR-A-2588181 discloses the use of fibres made from composite materials to reinforce totally or partially polymerized resin-base dental prostheses manufactured by pultrusion, injection, compression, moulding, or transfer. The resin is in partly polymerized form and may be an epoxy or polyester resin or any other resin, provided that it is compatible with the fibres used. The fibres can be of any nature, glass, ceramic, boron, boron carbide, silicon carbide, or synthetic, in the form of bundles of parallel fibres, which may be wrapped, woven, knit fabrics or strands. Each type of fibres has indications and shortcomings:

Parallel fibres are used in the zones subjected to strong loads but they are more rigid and difficult to work.

Wisps, cords and strands with a circular or oval cross-section of 1 mm or 2 mm are easier to handle on account of the weaving. They have little shape memory but do have the drawback of occupying more space and may interfere in occlusion.

Strips have the advantage of being flat and of occupying little occlusal space, but they are more rigid and have a high shape memory.

The documents U.S. Pat. No. 4,717,341 and U.S. Pat. No. 4,894,012 describe reinforcement elements able to be used as active or passive elements in orthodontics and in dental prostheses. These elements come in the form of elongate elements and in particular enable the teeth to be secured to one another. These elements are generally proposed in the state prior to polymerization and are formed by a photopolymerizable resin. They are referred to as “preimpregnates” or “prepeg”.

As represented in FIG. 1, a dental contention strip 1 is stuck onto dental surfaces 2 by means of a photopolymerizable composite glue by different known means. A spatula (not shown) is generally used to maintain the element on dental surface 2. Dental contention strip 1 and the glue are exposed to polymerize the polymerizable composites and to harden the whole assembly. Exposure is performed step by step, progressing from one tooth to another tooth.

As represented in FIG. 2, another technique consists in securing the dental contention strip 1 on dental surfaces 2 by means of a small band 3 transparent to light rays. Band 3 can be applied by mechanical means, suture threads, clamps, or by means of a preformed transparent cap splint prepared in a laboratory by means of any known method.

The state-of-the-art means for applying a dental contention strip on dental surfaces are difficult and long to implement. Application with a spatula or a band secured by mechanical means, spatulas, hooks, cap splints, or wires, is difficult in a context where the dental surfaces have to remain humidity-free. This results in gaps and a lack of co-optation of the splint on the dental surfaces which may compromise the longevity of the system.

Furthermore, when exposure is performed step by step, the light initiates polymerization of a larger length of contention strip than the part in contact with the targeted dental surface, and application of the partially hardened strip becomes difficult on the next tooth.

The document U.S. Pat. No. 5,921,778 discloses the use of woven threads sunk in a polymer matrix for application on teeth. This embodiment on the one hand requires the matrix to be formed at the level of the teeth and on the other hand requires the woven threads to be fixed onto the matrix.

The known means of the state of the art do not enable a contention strip to be applied on a complex surface by applying a pressure uniformly distributed on its whole surface and even less so by making the cross-section of the contention strip vary in uniform manner.

### Object of the Invention

The object of the invention is to avoid the drawbacks of the prior art and in particular to facilitate fitting of a dental contention strip. This object is achieved by the appended claims and in particular by the fact that the reinforcement preform is formed by a cord made from woven fibres, the cord is impregnated and filled with a polymerizable resin and is able, by isostatic crushing, to take the shape of a strip without breaking of the woven fibres constituting the cord, the polymerizable resin being able to creep through the cord when the latter is subjected to the isostatic crushing.

Another object of the invention is to provide a method enabling the initially tubular reinforcement preform to be shaped to form a dental contention strip by exerting an isostatic pressure on said preform, application of the pressure simultaneously enabling the initially tubular cord to be crushed into the form of a strip and the polymerizable resin to be expelled from the tubular cord to form the two lateral parts on each side of the strip, and by then polymerizing the polymerizable resin.

It is a further object of the invention to obtain a dental contention strip made from composite material having a base which is formed by a polymer material and by reinforcement means formed by a cord made from woven fibres, said contention strip being formed by a central part comprising the reinforcement means, situated between two lateral parts only formed by the polymer material, said reinforcement means being sunk in the polymer material, the contention strip having a thickness that is less than or equal to 0.7 mm, said lateral parts representing at least 8% of the total mass of said contention strip, and said cord made from fibres being flattened into the form of a strip.

Another object of the invention is relative to the use of a hand-held instrument with a preform for fitting a dental element contention, said instrument comprising:
gripping elements provided with a recipient receiving the dental reinforcement preform in pre-impregnated state before polymerization,
means for applying and forming said preform, said preform having a first initial shape and being able to take a second shape, by crushing, in the form of a band or strip, different from the first shape,
   the recipient communicating with the means for applying and forming so as to dispense said preform in continuous manner, and the means for applying and forming being formed in such a way as to apply said preform while at the same time transforming it into its second shape, and the means for applying and forming comprising an end-part that is opaque to light rays, terminated by an application head transparent to light rays.

### BRIEF DESCRIPTION OF THE DRAWINGS

Other advantages and features will become more clearly apparent from the following description of particular embodiments of the invention given for non-restrictive example purposes only and represented in the appended drawings, in which:

FIGS. 1 and 2 schematically represent, in perspective, a dental contention strip according to the prior art fitted on the dentition of a person.

FIGS. 3 and 4 schematically represent a contention strip according to a particular embodiment of the invention, respectively in perspective and in cross-section.

FIGS. 5 and 6 schematically represent a reinforcement preform for obtaining a contention strip according to FIGS. 3 and 4, respectively in perspective and in cross-section.

FIGS. 7 and 10 schematically represent, in cross-section, different steps of a production method of a contention strip according to FIGS. 3 and 4.

FIG. 11 schematically represents, in perspective, a hand-held instrument according to a particular embodiment of the invention.

FIG. 12 schematically represents, in perspective, an enlargement of FIG. 5.

FIG. 13 schematically represents a top view of a method for using an instrument according to a particular embodiment of the invention.

FIG. 14 schematically represents, in perspective, a hand-held instrument with a preform according to a particular embodiment of the invention.

FIG. 15 schematically represents, in perspective, an enlargement of FIG. 14.

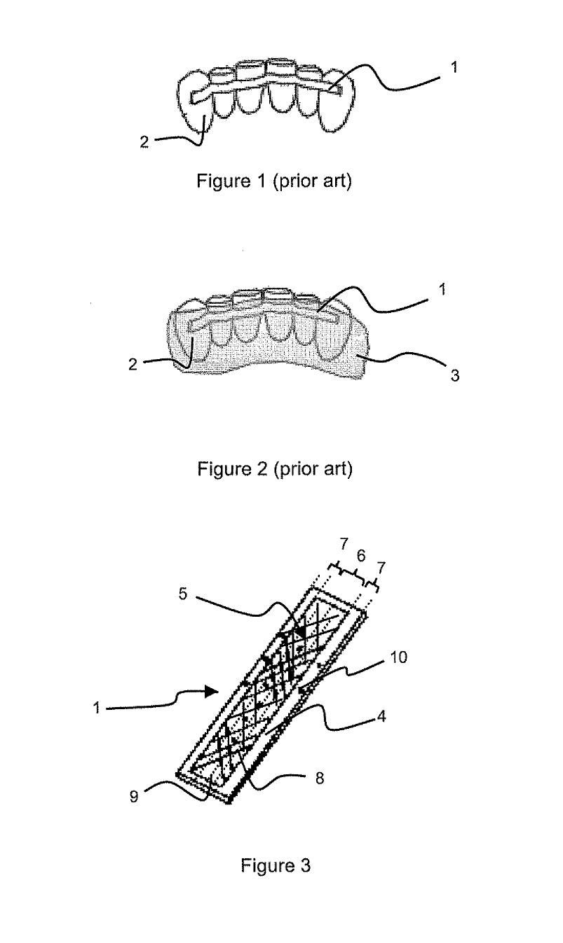

### DESCRIPTION OF PARTICULAR EMBODIMENTS

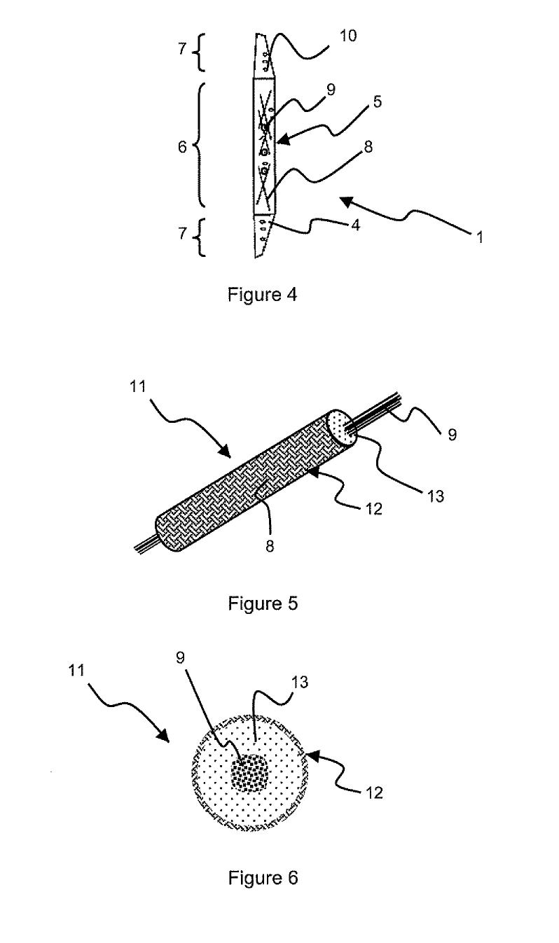

According to a particular embodiment represented in FIGS. 3 and 4, a dental contention strip 1 is formed by a composite material with a base formed by a polymer material 4 and reinforcement means 5.

Reinforcement means 5 are sunk in the polymer material 4.

Dental contention strip 1 is formed by a central part 6 between two lateral parts 7. Lateral parts 7 are adjacent to central part 6. In other words, central part 6 is preferably situated between the lateral parts.

Central part 6 comprises reinforcement means 5. Reinforcement means 5 are formed by a cord made from woven fibres 8, flattened into the form of a strip or a band. What is meant by woven fibres is that the fibres are woven or knitted.

The cord is preferably chosen from woven or knitted cords with low shape memory. The cord is for example formed by long woven or knitted fibres 8 with a particular weaving giving it a low shape memory.

What is meant by low shape memory is the inability to store an initial shape and therefore the inability to return to this initial shape after a deformation.

The long fibres forming the cord are preferably vitreous siliceous artificial mineral fibres, called glass, silica, quartz, or ceramic fibres, but they may also be polycrystalline vitreous artificial fibres such as for example alumina fibres and alumina silicates. The cords can also be formed by organic fibres such as polyolefines, polyamides or para-amides, polyethylene, polyurethanes or any other suitable polymer chosen by the person skilled in the art. Other fibres called natural fibres can also be used such as vegetal, animal natural or modified fibres.

The cord can if required be partially filled by unidirectional long fibres 9 designed to enhance the mechanical strength and the crushing resistance. Unidirectional long fibres 9 can be of the same nature as or of a different nature from woven fibres 8 forming the cord. These fibres can constitute a core of the cord and represent an impediment to reversion to the initial shape of the cord. Indeed, friction of the long fibres inside the cord prevents the cord which goes from an initial shape to a second shape from reverting spontaneously to the initial shape.

Lateral parts 7 are formed solely by polymer material 4 and represent at least 8% of the total mass of said contention strip 1. The 8% correspond to the mass fraction of polymer material 4 in the contention strip 1. Polymer material 4 can comprise additives 10 and/or colorants improving the mechanical and/or aesthetic properties of contention strip 1.

As represented in FIG. 4, contention strip 1 has an almost rectangular cross-section.

Contention strip 1 described above advantageously has a thickness less than or equal to 0.7 mm and presents improved mechanical properties. In particular, contention strip 1 adheres intimately to dental surfaces 2 of a person, or of a laboratory dental model, due in particular to the presence of the two lateral parts 7 devoid of fibres 8 and 9 bordering central part 6 of contention strip 1.

Central part 6 provides the necessary reinforcement to exert an efficient and advantageously strong contention, or securing, of a person's dentition.

Contention strip 1 described above can advantageously be obtained from a tubular reinforcement preform 11 represented in FIGS. 5 and 6, according to a particular production method.

According to a particular embodiment, a tubular dental reinforcement preform 11 formed by a tubular cord 12 made from woven fibres 8, impregnated and filled by a polymerizable resin 13 is used to achieve dental contention strip 1. Tubular cord 12 is impregnated with a polymerizable resin 13 in the state prior to polymerization. Tubular cord 12 is advantageously filled with at least 38% by mass of polymerizable resin 13, the percentage being calculated with respect to the total mass of the tubular reinforcement preform 11 (i.e. the mass fraction).

The choice of a mass percentage of 38% advantageously enables two lateral strips of polymer material representing 8% of the total mass of the contention strip to be obtained, after isostatic crushing of the cord.

Polymerizable resin 13 can be doped with one or more additives 10 and/or colorants to give it a consistence enabling it to creep without flowing through the fibres 8 of tubular cord 12 or to take a particular color.

The polymerizable resin preferably has a viscosity comprised between 1.5 Pa·s and 10⁶ to 10⁹ Pa·s at 20° C.

The resin constituting the impregnation gel of the fibres can be an organic resin of methacrylic ester type, in particular it can be polymethyl methacrylate (PMMA), urethane dimethacrylate (UDMA), bisphenol A and glycidyl methacrylate (BISGMA), n-ethylene dimethacrylate (N EDMA), ethyl methacrylate (EMA), triethylene glycol dimethacrylate (TEGMA), dimethacrylate modified by a carboxylic acid (TCB) or a mixture of these esters. But it can also be formed by any organic resin chosen by the person skilled in the art from organic resins compatible with the coating of the fibres, polymerization of which can also advantageously be initiated by an electromagnetic radiation.

The polymerizable resin is preferably photopolymerizable as this particular technology is easily able to be mastered in particular in the dental field.

In the following, although photopolymerizable resin will be referred to, the person skilled in the art will be able to use any type of polymerizable resin.

Tubular cord 12 forming the preform is chosen from cords able to take the form of a strip by isostatic crushing, without the woven fibres 8 constituting tubular cord 12 breaking. In particular, cord 12 is chosen from cords with low shape memory, woven or knitted.

Tubular cord 12 must be able to take two different conformations or positions, respectively before and after shaping of the tubular reinforcement preform 11; a tubular initial conformation and a flattened conformation in the form of a strip.

Cord 12 may comprise a core of unidirectional long fibres 9 designed to improve the mechanical strength and the crushing resistance, and to favour the absence of shape memory. Unidirectional long fibres 9 can be of the same nature as or of a different nature from woven fibres 8 constituting the cord. The volume of unidirectional long fibres 9 is determined such as to leave sufficient photopolymerizable resin 13 in tubular cord 12 to form lateral parts 7 of dental contention strip 1 by crushing of tubular cord 12.

In other words, the core is disposed in tubular cord 12, advantageously co-axially to the tube of cord 12. The core is separated from the inner surface of the tube of cord 12 by the photopolymerizable resin.

Tubular reinforcement preform 11 is produced by means of any known method from a cord that is hollow or partially filled with long fibres 9 and with photopolymerizable resin 13. In general manner, it can in fact be said that the tubular cord can comprise a tube, formed for example by woven or knitted fibres, and that the inner space of this tube can be filled by the resin. The fibre core can advantageously be arranged inside the tube and oriented along the longitudinal axis of the tube.

Furthermore, the polymerizable resin is able to creep through the cord when the latter is subjected to an isostatic crushing. What is meant by creep is that, when a pressure is applied on the cord, the resin can drain off through the cord.

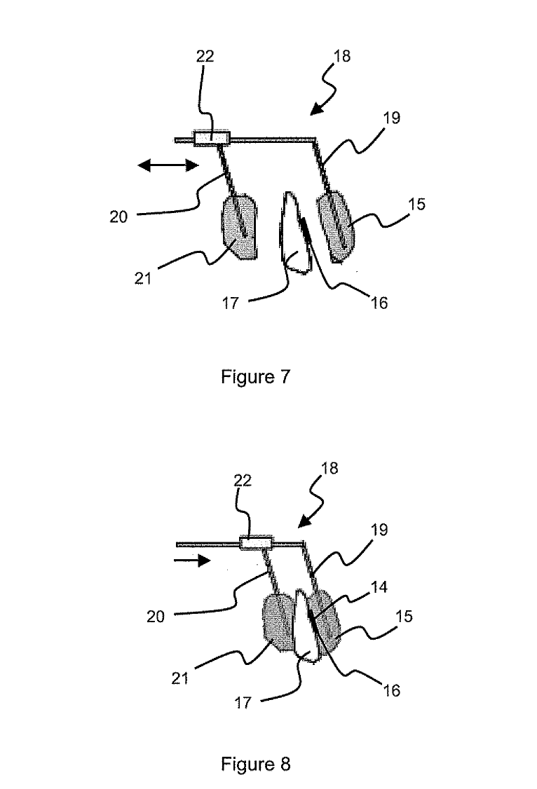

According to a particular embodiment represented in FIGS. 7 to 11, a production method enables dental contention strip 1 to be obtained from tubular reinforcement preform 11 described in the foregoing.

The method thus comprises at least two successive steps: shaping of the initially tubular reinforcement preform 11 by exerting an isostatic pressure on said preform 11, application of the pressure simultaneously crushing the initially tubular cord 12 into the form of a strip and expelling polymerizable resin 13 from tubular cord 12 to form the two lateral parts 7 on each side of the strip, and then polymerization of polymerizable resin 13. In the case of a photopolymerizable resin, polymerization is performed by exposure.

The production method can comprise the successive steps described hereafter, before shaping of the preform is performed.

As represented in FIGS. 7 and 8, a negative imprint 14 of contention strip 1 is made by means of a matrix 15, preferably transparent to light in the case of a photopolymerizable resin to perform polymerization of the resin by exposure of matrix 15, from a reproduction 16 of contention strip 1 secured in a defined position on a laboratory dental model 17 of a person.

Matrix 15 is formed by a shapeable and poly merizable (advantageously photopolymerizable) material. Matrix 15 is preferably formed by a transparent, shapeable and polymerizable plastic material. Matrix 15 is chosen from transparent plastic materials which do not adhere either to resins, or to waxes, or to the dental surfaces or to the laboratory plaster. Matrix 15 is advantageously chosen from vinylic polysiloxanes.

For example purposes, a reproduction 16 made from tackifying material of the shape, of the rectangular final cross-section of contention strip 1, is applied to the surface of laboratory dental model 17 so as to fix the location of the future splint on dental model 17. For example, for a tubular reinforcement preform 11 with a cross-section of 0.8 mm, reproduction 16 can have an almost rectangular cross-section having an indicative width and length respectively of 0.3 mm and 1.6 mm. What is meant by tackifying material is an adhesive, sticky material.

Matrix 15 can for example be applied and secured in the predefined position by means of an element holder 18, completely or partially transparent to light rays.

According to a particular embodiment represented in FIG. 7, element holder 18 comprises a first fixed branch 19 and a second branch 20 that is able to move along first fixed branch 19. First and second branches, 19 and 20, are provided respectively at their ends with matrix 15 and with a support 21.

As represented in FIG. 8, a slide 22 enables movement of second branch 20 in translation (horizontal arrow in FIG. 7) so as to pinch laboratory dental model 17. Shapeable and photopolymerizable matrix 15 then conforms to the surface of dental model 17 on which it is applied and imprints reproduction 16 so as to form the negative imprint 14.

The position is defined according to the intended final shape on the person's dentition. Reproduction 16 can be made for example from an analogue made from tackifying material by means of any known method.

Preferably, the tackifying material can be a wax, and it can advantageously be eliminated by simple traction without leaving any residue. The wax can be a polymerizable or photopolymerizable wax.

After reproduction 16 has been position/left to harden, the set of element holder/reproduction is removed (horizontal arrow in FIG. 8) and reproduction 16 made from tackifying material (for example polymerized wax) is eliminated.

As represented in FIG. 9, after the step of producing negative imprint 14, tubular reinforcement preform 11 described above is then housed in negative imprint 14 so that a part of tubular reinforcement preform 11 is salient from negative imprint 14. Tubular reinforcement preform 11 is thus inserted in imprint 14, possibly coated (or painted) beforehand with a resin of the same nature as photopolymerizable resin 13.

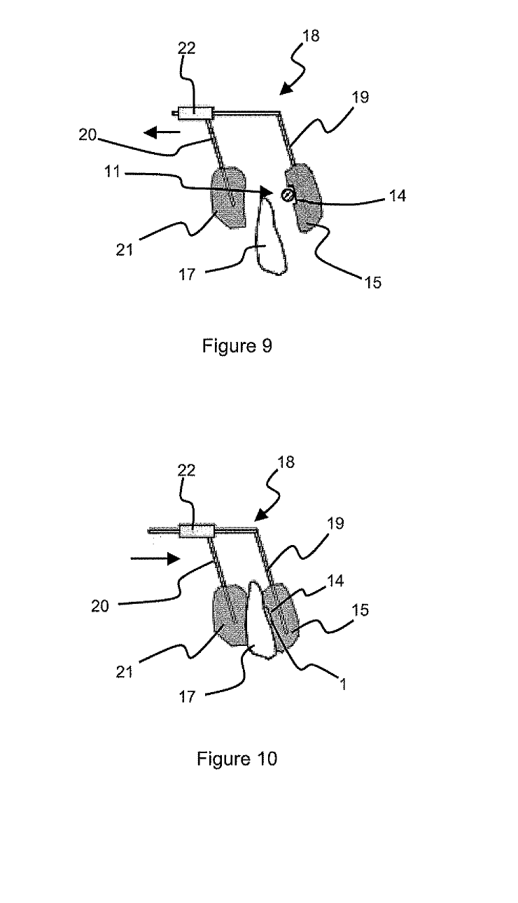

As represented in FIG. 10, the subsequent step consists in applying matrix 15 provided with tubular reinforcement preform 11 onto laboratory dental model 17 in the predefined position.

The initially tubular reinforcement preform 11 is shaped by exerting an isostatic pressure on reinforcement preform 11. The isostatic pressure is advantageously exerted by means of an element holder 18 (see horizontal arrow in FIG. 10). As previously, element holder 18 is inserted on laboratory dental model 17 and second branch 20 is slid transversely until it enables dental model 17 to be pressed between support 21 and matrix 15 provided with tubular reinforcement preform 11.

Applying the pressure simultaneously enables cord 12 to be crushed and photopolymerizable resin 13 to be expelled from cord 12, to transform initially tubular cord 12 into a strip and to form the two lateral parts 7 of dental contention strip 1. To foster expulsion of photopolymerizable resin 13 without flowing, the consistence of photopolymerizable resin 13 is adjusted for example by addition of additives 10 well known to the person skilled in the art.

For example, the additives can be primary plasticizers such as phtalates, adipates, sebacates, epoxidized oils, polyester plasticizers, phosphates, glycol and derivatives or secondary plasticizers such as fatty acid esters, chlorinated organic derivatives, or derivatives of toluenesulfonic acid. They can also be formed by charges, granular or fibrous stiffeners of mineral, vegetal or synthetic origin, in the form of powders, fibres, filaments, foils or small balls.

According to another example, the additives can be granular charges, wood flour, calcium carbonate, kaolin, clay, mica, slate, talc, or silica powders, diatoma flour, barium and calcium sulphates, alumina and other metal oxide powders such as carbon blacks, colloidal graphite or even ground waste of synthetic resins.

For the fibrous charges, they can be cellulose fibres such as hemp, jute, ramie, cotton, rayon, or certain synthetic fibres can be used. They are advantageously siliceous fibres.

Colorants and pigments can also be used to give a particular shade or radio-opacity. They can be of mineral, organic or mixed origin, soluble or insoluble in the resin.

The colorants and/or pigments soluble in the resin can be mono-azoics or diazoics carrying —OH or —NH2 groups, anthraquinone amines, nigrosine or induline bases, etc.

The colorants and/or pigments insoluble in the resin are for example minerals such as metal salt oxides of titanium, lead, chromium, manganese, cobalt, cadmium, iron, etc.

The organic colorants and/or pigments are preferably copulated azoics and diazoics, certain indanthrene colorants, etc.

The mixed colorants and/or pigments are for example coloured salts of organic acids.

Element holder 18 forming means for applying tubular reinforcement preform 11 thus enables woven or knitted tubular cord 12, having a circular or oval cross-section, to be transformed into a strip of substantially rectangular cross-section occupying a reduced occlusal space. Tubular cord 12 has a cross-section the largest dimension of which is conventionally a few millimetres.

The strip formed in this way has an indicative thickness of about 35% of the largest dimension of the cross-section of tubular cord 12 and an indicative width of about 180% of the largest dimension of the cross-section of tubular cord 12.

As represented in FIG. 10, the exerted pressure enables photo-polymerizable resin 13 to be made to creep through the initially tubular cord 12 and to adjust to the surface of laboratory dental model 17.

Photopolymerizable resin 13 has a viscosity such that photopolymerizable resin 13 can both be expelled from cord 12, through woven or knitted fibres, and at the same time not infiltrate into the gaps of the dental model.

Application of the isostatic pressure therefore advantageously simultaneously enables initially tubular cord 12 to be transformed into a strip and said cord to be concomitantly fashioned on the dental model.

After application on a laboratory dental model 17, tubular cord 12 undergoes a spatial transformation to become a strip. Application of an isostatic force by means of element holder 18 over the whole surface of tubular cord 12 enables transformation of the latter into a strip of indicative thickness of about 35% of the largest dimension of the cross-section of tubular cord 12.

This transformation is made possible by a particular weaving of fibres 8 of tubular cord 12 enabling crushing thereof without breaking of fibres 8 and expulsion from cord 12 of a part of photopolymerizable resin 13 to form lateral parts 7 of final contention strip 1, devoid of fibres 8 and 9.

As a first example, tubular cord 12 with a cross-section of 0.8 mm will be transformed into a strip of globally rectangular cross-section having an indicative width and length respectively of 0.3 mm and 1.6 mm. The strip is bordered by two bands formed only by photopolymerizable resin 13, devoid of fibres 8 and 9, each having an indicative length of 0.4 mm and which will constitute the two lateral parts 7 of the final contention strip 1. The length of the bands has to be sufficiently important to obtain an advantageous effect on the adhesion of final contention strip 1.

As a second example, tubular cord 12 with a cross-section of 1.5 mm will be transformed into a strip of globally rectangular cross-section having an indicative width and length respectively of 0.6 mm and 3.4 mm. The strip is bordered by two bands formed only by photopolymerizable resin 13, devoid of fibres 8 and 9, each having an indicative length of 0.5 mm.

It is thus the combination of a particular weaving of tubular cord 12, of a suitable consistence of photopolymerizable resin 13 and of an isostatic force applied on tubular cord 12 of preform 11 by element holder 18 which enables transformation of tubular cord 12 into a strip with an indicative thickness of about 35% of the largest dimension of the cross-section of tubular cord 12, bordered by two lateral parts devoid of fibres 8 and 9 and formed only by photopolymerizable resin 13, and possibly by additives 10.

The last step consists in polymerizing photopolymerizable resin 13 by exposure of matrix 15 by any known method to form contention strip 1. Photopolymerizable resin 13 is for example subjected to the radiation supplied by a light source (not represented) passing through matrix 15. The exposure polymerizes photopolymerizable resin 13 which hardens in its definitive form. The flattened cord 12 in the form of a strip occupies central part 6 and polymerized resin 13 forms polymer material 4.

The production method according to the invention implements an acceptable mass photopolymerization process of tubular cord 12 transformed into a strip, while at the same time maintaining final contention strip 1 intimately adjusted to laboratory dental model 17 by means of an element holder instrument constituted by a material transparent to light rays.

The production method according to the invention enables a dental contention strip 1 to be produced comprising reinforcement means 5 in the form of a strip occupying a reduced occlusal space from a tubular reinforcement preform 11 comprising a tubular cord 12 having a low shape memory, before being implemented, and being easy to handle. In other words, after the polymerization step, it is possible to obtain a contention strip made from composite material having a base formed by a polymer material 4 and reinforcement means 5 formed by a cord made from woven fibres 8, said contention strip 1 being formed by a central part 6 comprising reinforcement means 5, situated between two lateral parts 7 constituted only by polymer material 4, said reinforcement means 5 being sunk in polymer material 4.

According to an alternative embodiment, the negative imprint referred to in the foregoing can have larger lateral and longitudinal dimensions than those of the final contention strip which it is required to obtain. The depth of the imprint will on the other hand be calculated so as to equal the final thickness of the contention strip. In this example, the viscosity of the polymer will be adjusted to correctly delineate the lateral bands of the contention strip.

According to a particular embodiment, reinforcement preform 11 described in the foregoing can be fitted and transformed into a dental contention strip by means of a hand-held instrument. The hand-held instrument is advantageously used for placing the contention strip, also called dental contention element 1 in the remainder of the present description. This enables both distribution, application and forming of reinforcement preform 11 designed to be polymerized once it has been applied on the dental surfaces of a person or of a laboratory dental model to form dental contention element 1.

According to a particular embodiment represented in FIGS. 3 and 4, dental contention element 1 is formed by fibres, resin and charges in the state prior to polymerization and photopolymerizable on a dental surface including at the level of the inter-dental spaces.

According to a particular embodiment represented in FIGS. 11 to 15, a hand-held instrument for fitting a dental contention element 1 comprises gripping elements 111 provided with a recipient 112 designed to receive dental reinforcement preform 11 and means for applying and forming 114 reinforcement preform 11.

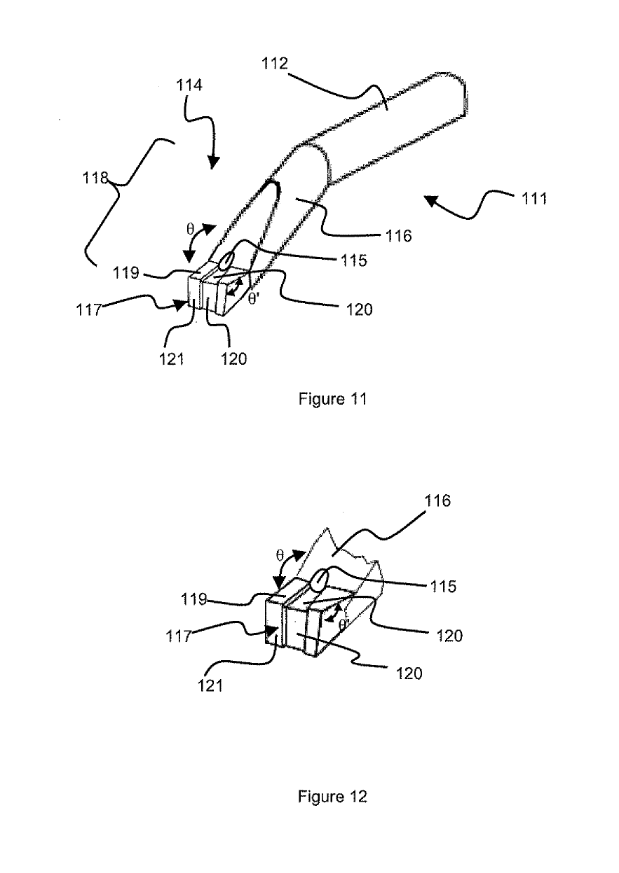

As represented in FIGS. 11 to 12, recipient 112 communicates with elements for applying and forming 114 so as to dispense reinforcement preform 11 in continuous manner. In particular, gripping elements 111 are formed by a hollow tube of application pen type terminated by the elements for applying and forming 114. The internal cavity of the tube then forms recipient 112 in which reinforcement preform 11 is housed. Recipient 112 is advantageously connected to the elements for applying and forming 114 via an opening 115 (FIGS. 11 and 12).

Elements for applying and forming 114 comprise an end-part 116 opaque to light radiation, terminated by an application head 117 transparent to light radiation. Application head 117 extends beyond opaque end-part 116 to form one end of the hand-held instrument.

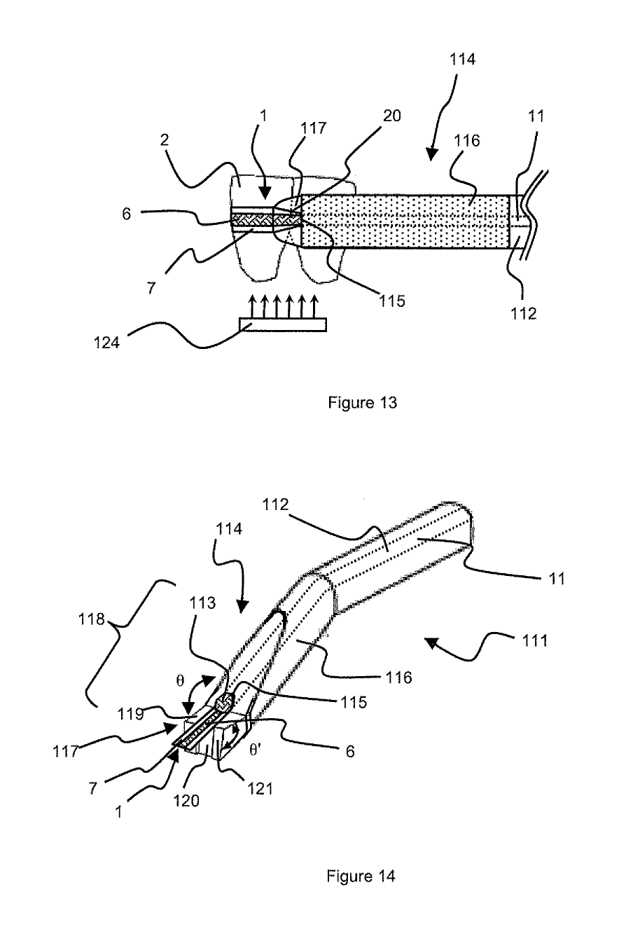

Elements for applying and forming 114 comprise a zone 118 (FIG. 11) designed to be in contact with the dental surfaces 2 (FIG. 13) when placing of dental contention element 1 is performed.

Application head 117 is constituted by a reversibly deformable material transparent to light rays and to the materials constituting preform 11 and/or dental contention element 1. What is meant by inert is the fact that the reversibly deformable material does not adhere and does not chemically react to the materials constituting preform 11 and/or dental contention element 1. What is meant by reversibly deformable is a material which deforms when it is subjected to a mechanical stress and reverts to its initial shape once the stress has been removed.

The reversibly deformable material can advantageously be an elastomer polymer. In particular, the reversibly deformable material is preferably chosen from silicones; polyamides, advantageously of Nylon® type, and poly-oxymethylenes (abbreviated to “POM”).

Application head 117 comprises a first surface 119 provided with an open half-groove 120. What is meant by open half-groove 120 is a slot formed along first surface 119 to form a channel.

The dimensions of open half-groove 120 are determined by the projected final shape of dental contention element 1. The cross-section of open half-groove 120 in application head 117 is calculated to obtain flattening of reinforcement preform 11 on outlet from opening 115.

Contact area 118 is at least partially formed by first surface 119 of application head 117.

Opaque end-part 116 comprises a bevelled surface adjacent to first surface 119 of application head 117 and constituting a part of contact area 118. The bevelled surface forms an angle 8 with first surface 119. The angle θ is chosen so as to optimize the contact between contact area 118 and dental surfaces 2. The angle θ is defined in order to optimize application of the hand-held instrument on dental surfaces 2, in particular in order to enable application of a force on the hand-held instrument necessary to perform crushing of reinforcement preform 11 and imprinting of the latter in the form of contention element 1. The angle θ is preferably comprised between 90° and 130°.

According to a preferred embodiment, application head 117 advantageously comprises a second surface 121 adjacent to first surface 119. Second surface 121 forms a convex dihedron with first surface 119 at the end of the hand-held instrument. The convex dihedron preferably has an angle θ′ able to vary between 20° and 150°.

Half-groove 120 extends from opening 115 to the tip of the dihedron. Half-groove 120 advantageously extends from first surface 119 to second surface 121 of the convex dihedron without discontinuity.

Contact area 118 is preferably formed by the bevelled surface of opaque end-part 116, first surface 119 and second surface 121.

As represented in FIGS. 5 and 6, a reinforcement preform 11 used for the hand-held instrument according to the invention, has a first initial shape. Reinforcement preform 11 is able to take a second shape, by crushing, that is different from the first shape. The initial first shape (FIGS. 5 and 6) is advantageously a tubular shape and the second shape is the form of a strip or band corresponding to the shape of contention element 1 (FIGS. 3 and 4).

Tubular cord 122 is advantageously able to take two different shapes or positions, respectively before and after shaping of reinforcement preform 11 in its first form by the hand-held instrument. Advantageously, as suggested in the foregoing, the cord can be of the type of cord 12 of FIGS. 5 and 6. Thus, in its first form, the cord can have a tubular initial shape (FIGS. 5 and 6) and, in its second form, a flattened shape in the form of a band or a strip (FIGS. 3 and 4).

According to a particular embodiment represented in FIGS. 13 to 15, reinforcement preform 111 used for the hand-held instrument is designed to form dental contention element 1 by application of dental reinforcement preform 11 on dental surfaces 2 while at the same time exposing the means for applying and forming 114 when application is performed.

The use of the hand-held instrument consists in loading tubular reinforcement preform 11 in recipient 112 making one of its ends exit via opening 115 and engaging it in the half-groove 120 at least of the first surface 119 of application head 117.

The hand-held instrument can be of use-once only type or rechargeable. In the latter case, recipient 112 and means for applying and forming 114 constitute two removable parts of the instrument.

As represented in FIG. 13, contact area 118 is then applied on dental surfaces 2 so as to crush tubular reinforcement preform 11 between dental surfaces 2 and at least the first surface 119 of application head 117. First surface 119 of application head 117 is at least partially in contact with dental surfaces 2 to enable crushing of tubular reinforcement preform 11.

Means for applying and forming 114 are formed in such a way as to apply reinforcement preform 11 while at the same time transforming it into its second shape.

As represented in FIG. 13, reinforcement preform 11 is applied on dental surfaces 2 and transformed into a band or strip by moving the hand-held instrument, step by step, from one tooth to the other.

As represented in FIG. 13, half-groove 120 in particular has a cross-section that is rectangular or oval or rectangular with rounded corners, to form a dental contention element 1 having the form of a band or a strip.

Half-groove 120 has a rectangular cross-section equal to 2/10±20% of the original cross-section of reinforcement preform 11.

Reinforcement preform 11 exits from opaque end-part 116 at the level of application head 117 to run in half-groove 120 and at the same time to be shaped.

Open half-groove 120 constitutes a negative imprint of reinforcement preform 11 in its second form and is shaped so as to enable reinforcement preform 11 to be run in half-groove 120, from opening 115 to the end of the instrument.

Half-groove 120 is preferably shaped in such a way that reinforcement preform 11 in its second form advantageously has an indicative thickness less than or equal to 0.7 mm.

In particular, the surface of the cross-section of half-groove 120 is smaller than the surface of the cross-section of opening 115 in order to crush reinforcement preform 11 on outlet from recipient 112 and to obtain reinforcement preform 11 in its second form.

Opening 115 has dimensions adjusted to the dimensions of reinforcement preform 11 in the form of a band or strip so as to easily extract tubular reinforcement preform 11 from recipient 112 while at the same time keeping it in a defined position enabling crushing of tubular reinforcement preform 11 between dental surfaces 2 and contact area 118.

Recipient 112 can advantageously comprising a compartment (not shown) containing photopolymerizable glue in fluidic communication with opening 115 so as to deliver the glue to impregnate reinforcement preform 11 before being input to means for applying and forming 114. The glue is designed to coat dental surfaces 2 when application of dental contention element 1 takes place.

The hand-held instrument thus intimately applies reinforcement preform 11 on dental surfaces 2 of a person or of a laboratory model to transform it into a band or a strip having a central part bordered by two lateral parts.

The central part and lateral parts, after polymerization by exposure, respectively form central part 6 and lateral parts 7 of dental contention element 1.

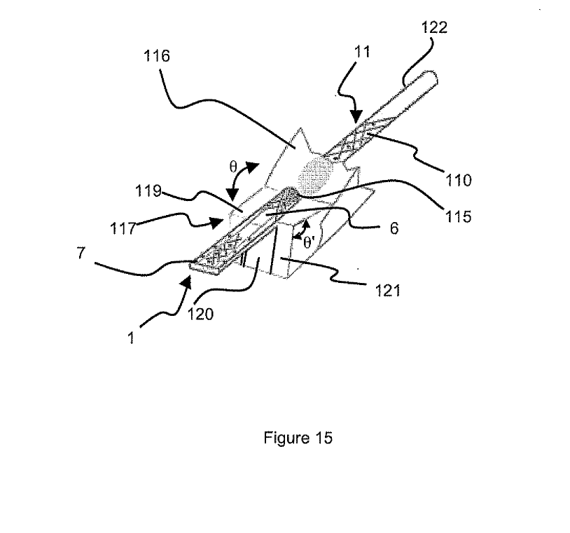

As represented in FIGS. 14 and 15, application of a pressure by means of application head 117 simultaneously enables tubular cord 122 to be crushed and photopolymerizable resin 13 to be expelled (as represented in FIG. 6) to the outside of cord 122, to transform initially tubular cord 122 into a strip and form the two lateral parts 7 of dental contention element 1. To foster expulsion of photopolymerizable resin 13 without flowing, the consistence of photopolymerizable resin 13 is adjusted, for example by addition of one or more additives 110 well known to the person skilled in the art and set out in the foregoing.

The woven or knitted, tubular cord 122, having a circular or oval cross-section is transformed into a strip or a band of substantially rectangular cross-section occupying a reduced occlusal space. Tubular cord 122 has a cross-section the largest dimension of which is conventionally a few millimetres.

The strip or band formed in this way has an indicative thickness of about 35% of the largest dimension of the cross-section of the tubular cord 122 and an indicative width of about 180% of the largest dimension of the cross-section of the tubular cord 122.

As represented in FIGS. 14 and 15, the pressure exerted enables photo-polymerizable resin 13 to be made to creep through the initially tubular cord 122 and to perfectly follow the outlines of dental surfaces 2 either of a person or of a laboratory dental model.

After application on dental surfaces 2, the indicative thickness of tubular cord 122 is advantageously about 35% of the largest dimension of the cross-section of tubular cord 122.

Polymerization can then be performed as described in the foregoing in the last step consisting in polymerizing the photopolymerizable resin by exposure. The method in fact remains substantially identical, the only difference being that the application head acts as the matrix. Advantageously, the flexibility of the application head enables the future contention element to be shaped according to the force exerted on the latter.

Light source 124 (FIG. 13), for example a lamp with blue LEDs, enables the part of reinforcement preform 11 contained in application head 117 transparent to light rays to be exposed, polymerized and therefore stuck onto dental surfaces 2, through the translucent and deformable material. Only the part of reinforcement preform 11 situated at the level of application head 117 is exposed to the light rays emitted by the LED lamp. Opaque end-part 116 upstream from opening 115 prevents any exposure able to cause polymerization of the rest of reinforcement preform 11. Reinforcement preform 11 is then tensed by a lateral movement of the instrument while at the same time keeping a pressure on dental surfaces 2, and the dihedron of application head 117 is inserted into the next inter-dental space, and so on.

The whole of dental contention element 1 is thus achieved by application on dental surfaces 2, transformation and polymerization, step by step and tooth to tooth.

According to a particular embodiment that is not represented, the hand-held instrument comprises light source 124 located in gripping means 111 so as to expose application head 117. Light source 124 can be fixed on gripping means 111 and directed in such a way as to expose application head 117 and polymerize photopolymerizable resin 13.

The hand-held instrument described above enables distribution and shaping of a dental contention element or dental splint and also of the glue by means of which the splint can be stuck on a dental surface.

The hand-held instrument enables targeted polymerization of a part of the reinforcement preform, transformed by the instrument in the second form, without polymerizing the rest of the reinforcement preform. Likewise, the hand-held instrument according to the invention is shaped in such a way as to conform to the complex surfaces in particular due to its application head made from flexible and deformable material, in the form of a dihedron, able to apply the preform in the inter-dental spaces.

The dental contention element thus distributed by the hand-held instrument according to the invention presents itself in the form of an improved dental contention element which adheres intimately to the dental surfaces. Use of the hand-held instrument described above with the preform thereby facilitates fitting of the contention strip.

It can in fact be considered, according to a particular embodiment, that the head is configured to transform preform 11 from the tubular initial first shape into the second shape in the form of a band or strip.

1-14. (canceled)

15. A tubular dental reinforcement preform formed by a tubular cord made from woven fibres, wherein the cord is impregnated and filled by a polymerizable resin and is able to take the form of a strip, by isostatic crushing, without breaking of the woven fibres forming the cord, the polymerizable resin being able to creep through the cord when the cord is subjected to the isostatic crushing.

16. The tubular dental reinforcement preform according to claim 15, wherein the cord comprises a core made from unidirectional long fibres,

17. The tubular dental reinforcement preform according to claim 15, wherein the cord is chosen from woven or knitted cords with a low shape memory,

18. The tubular dental reinforcement preform according to claim 15, wherein the tubular cord is filled with at least 38% mass of polymerizable resin, said percentage being calculated with respect to the total mass of the tubular reinforcement preform.

19. A method for producing a dental contention strip from the reinforcement preform according to claim 15, comprising the following successive steps:
forming the initially tubular reinforcement preform by exerting an isostatic pressure on said preform, application of the pressure simultaneously enabling the initially tubular cord to be crushed into the form of a strip and the polymerizable resin to be expelled from the tubular cord to form two lateral parts on each side of the strip, and
polymerizing the polymerizable resin.

20. The method according to claim 19, comprising the following successive steps, before shaping of the preform:
making a negative imprint of the dental contention strip with a matrix from a reproduction of said strip, secured in a predefined position on the laboratory dental model of a person,
housing the tubular reinforcement preform in the negative imprint so that a part of said preform is salient from the imprint,
applying the matrix provided with said preform on the laboratory dental model in a predefined position.

21. The method according to claim 20, wherein the reproduction is made from an analogue made from wax.

22. The method according to claim 20, wherein the matrix is applied and secured in the predetermined position an element holder.

23. The method according to claim 20, wherein the matrix is formed by a material chosen from the vinylic polysiloxanes.

24. The method according to claim 19, wherein the polymerizable resin is photopolymerizable.

25. The method according to claim 20, wherein the matrix is transparent to light, and the polymerization step of the photopolymerizable resin is performed by exposure of the matrix.

26. The method according to claim 19, wherein, after the polymerization step, a contention strip made from composite material is obtained the base of which being formed by a polymer material and by reinforcement elements formed by a cord made from woven fibres are obtained, said contention strip being formed by a central part comprising the reinforcement elements, situated between two lateral parts formed solely by the polymer material, said reinforcement elements being sunk in the polymer material.

27. A dental contention strip made from composite material the base of which is formed by a polymer material and by reinforcement elements formed by a cord made from woven fibres, said contention strip being formed by a central part comprising the reinforcement elements, situated between two lateral parts formed solely by the polymer material, said reinforcement elements being sunk in the polymer material, wherein:
the contention strip has a thickness less than or equal to 0.7 mm,
said lateral parts represent at least 8% of the total mass of said contention strip, and
said cord made from fibres is flattened into the form of a strip.

28. A hand-held instrument configured to transform a tubular reinforcement preform according to claim 15 into a dental contention strip, said instrument comprising:
gripping elements provided with a recipient configured to receive the dental reinforcement preform in the pre-impregnated state before polymerization,
elements configured to apply and form said preform, said preform having an initial first shape and being able, by crushing, to take a second shape, in the form of a band or a strip, different from the first shape,
the recipient communicating with the elements for applying and forming so as to be configured to dispense said preform in continuous manner, and the elements for applying and forming being formed in such a way so as to be configured to apply said preform while transforming it into its second shape, and the elements for applying and forming comprising an end-part opaque to light rays, terminated by an application head transparent to light rays.
